(19) United States
(12) Patent Application Publication
(10) Pub. No.: US 2010/0255224 A1
(43) Pub. Date: Oct. 7, 2010

(54) Sealant For Insulating Glass Unit

(76) Inventors: Frederic Gubbels, Houtain-le-Val (BE); Stephanie Lobry, Cousolre (FR); Patrick Vandereecken, Court-Saint-Etienne (BE)

Correspondence Address: HOWARD & HOWARD ATTORNEYS PLLC, 450 West Fourth Street, Royal Oak, MI, 48067, US

(21) Appl. No.: 12/670,302

(22) PCT Filed: Jul. 23, 2008
(86) PCT No.: PCT/EP08/59648

§ 371 Date: Jun. 17, 2010

(30) Foreign Application Priority Data
Jul. 23, 2007 (GB) 0714257.3

(51) Int. Cl. E06B 3/66; C08L 83/05; E06B 3/663

(52) U.S. Cl. 428/34; 524/588

(57) ABSTRACT

This invention relates to the use of an acrylate polymer containing curable silyl groups as a secondary sealant in an insulating glass unit and to a secondary sealant for an insulating glass unit having low gas permeability, in which the secondary sealant comprises an acrylate polymer containing curable silyl groups.

This invention relates to insulating glass units comprising two glass sheets held apart by a spacer. The insulating glass unit in general comprises at least two glass sheets and may contain more than two panes of glass, for example a triple pane unit comprising a central pane separated from two outer panes by spacers. Insulating glass units usually have a secondary sealant between the edges of the glass sheets outside the spacer. This invention relates in particular to an improved secondary sealant for insulating glass units.

Insulating glass units and their manufacture are described for example in U.S. Pat. No. 5,961,759, EP-B-805254 and EP-B-714964. The spacer can be a hollow section, generally containing a desiccant, held between the glass sheets by one or more sealant materials. Such a hollow section can be metal, for example an aluminium box spacer such as that described in U.S. Pat. No. 4,817,354, or plastic or a plastic/metal composite as described in U.S. Pat. No. 5,460,862 or EP-B-852280. The spacer can be a mastic layer containing a desiccant and formed around a reinforcement such as a corrugated metal reinforcement, as described for instance in U.S. Pat. No. 5,270,091. The spacer can alternatively be a foamed plastics material containing a desiccant, held between the glass sheets by a sealant, as described for example in U.S. Pat. No. 5,156,894 or U.S. Pat. No. 4,994,309, or the spacer can be a thermoplastic spacer containing a desiccant. Such a thermoplastic spacer if applied as a hot melt can act as both spacer and sealant but is often used with an outer secondary sealant layer at the edge of the glass sheets as described in EP-B-916801. In this application we use the term ‘secondary sealant’ to mean any sealant applied between the edges of the glass sheets outside the spacer, whether or not the spacer itself has any sealant properties.

Sealant compositions are viscous materials used to seal joints and cavities in structures. They are typically moisture cured being applied to a joint to be sealed in the form of a viscous paste which cures in time to form a rubbery solid, effectively sealing the joint to which it has been applied. In the construction industry, insulating glazing secondary sealants are mainly formulated around silicone, polysulphide or polyurethane. A low permeability spacer is used to provide gas barrier properties. Silicone based sealants are generally exhibiting the best resistance to weathering and ageing. However, the silicone matrix is the most permeable to gas, which can be critical in case of primary seal (spacer) failure. In that respect polyurethane and polysulphide are providing a better barrier to gas, but are less durable systems in comparison with silicone sealants.

EP-A-1586605, EP-A-1746133 and WO-A-2001-59011 all describe acrylate polymers containing curable silyl groups and suggest their use as sealants or adhesives, but none of them suggest use as a secondary sealant in an insulating glass unit.

In instances where the adhesive properties between the materials forming the joint and the sealant selected to seal the joint are inadequate to produce sufficient adhesion to effect a seal a primer may be utilised. Primers are typically low viscosity coatings which are applied by e.g. painting surfaces of the materials forming the joint to be sealed prior to the application of the sealant to improve adhesion and/or durability of the bond. They do not function as sealants as they are unable to seal the joint. JP 2007-138096 describes a primer composition for use in combination with a sealant, preferably a polyisobutylene based sealant, which comprises a hydrolysable silyl group containing polymer having an acrylic polymer backbone, an organopolysiloxane having silicon bound hydroxyl and/or alkoxy groups, an amino group containing silane, a condensation catalyst and an organic solvent.

According to one aspect of the invention an acrylate polymer containing curable silyl groups is used as a secondary sealant in an insulating glass unit. The acrylate polymer containing curable silyl groups is used in a secondary sealant composition which upon application and curing forms a secondary sealant in an insulating glass unit.

According to a second aspect of the invention an acrylate polymer composition is used as a secondary sealant in an insulating glass unit, wherein the acrylate polymer composition comprises an acrylate polymer having ethylenically unsaturated groups, an organosilicon material having Si—H groups, and a hydrosilylation catalyst.

There is also provided a method for fabricating an insulating glass unit comprising: using an acrylate polymer containing curable silyl groups as a secondary sealant in the insulating glass unit. In this method the acrylate polymer composition comprises:

a) an acrylate polymer having ethylenically unsaturated groups,
b) an organosilicon material having Si—H groups, and
c) a hydrosilylation catalyst.

Furthermore there is provided a secondary sealant in an insulating glass unit comprising an acrylate polymer containing curable silyl groups.

The invention includes a sealed insulating glass unit comprising two glass sheets held apart by a spacer, with a secondary sealant between the edges of the glass sheets outside the spacer, characterised in that the secondary sealant comprises an acrylate polymer containing curable silyl groups, or comprises an acrylate polymer composition comprising an acrylate polymer having ethylenically unsaturated groups, an organosilicon material having Si—H groups, and a hydrosilylation catalyst.

We have found that a secondary sealant based on a silyl functional acrylate polymer, or on an acrylate polymer having ethylenically unsaturated groups, an organosilicon material having Si—H groups, and a hydrosilylation catalyst, exhibits both a low permeability to gas and a very good resistance to weathering and ageing, as well as good mechanical properties and high adhesion to glass.

In a preferred acrylate polymer containing curable silyl groups, the curable silyl groups are hydrolysable silyl groups. The hydrolysable silyl groups preferably contain alkoxy groups bonded to silicon, although alternative hydrolysable groups such as acetoxy can be used. The hydrolysable silyl groups can for example be dialkoxyalkylsilyl groups, dialkoxyalkenylsilyl groups or trialkoxysilyl groups. Dialkoxyalkylsilyl or dialkoxyalkenylsilyl groups of the formula —SiR′(OR)₂, in which R represents an alkyl group having 1 to 4 carbon atoms, most preferably methyl or ethyl, and R′ represents an alkyl or alkenyl group having 1 to 6 carbon atoms, are particularly preferred. Examples of such dialkoxyalkylsilyl groups are dimethoxymethylsilyl, diethoxymethylsilyl and diethoxymethylsilyl groups. Examples of dialkoxyalkenylsilyl groups are dimethoxyvinylsilyl and diethoxyvinylsilyl. Examples of trialkoxysilyl groups are trimethoxysilyl and triethoxysilyl.

The acrylate polymer is an addition polymer of acrylate and/or methacrylate ester monomers, which comprise at least 50% by weight of the monomer units in the acrylate polymer. Examples of acrylate ester monomers are n-butyl, isobutyl, n-propyl, ethyl, methyl, n-hexyl, n-octyl and 2-ethylhexyl acrylates. Examples of methacrylate ester monomers are n-butyl, isobutyl, methyl, n-hexyl, n-octyl, 2-ethylhexyl and lauryl methacrylates. The acrylate polymer preferably has a glass transition temperature T_{g} below ambient temperature; acrylate polymers are generally preferred over methacrylates since they form lower T_{g} polymers. Polybutyl acrylate is particularly preferred. The acrylate polymer can contain lesser amounts of other monomers such as styrene, acrylonitrile or acrylamide. The acrylate(s) can be polymerized by various methods such as conventional radical polymerization or living radical polymerization such as atom transfer radical polymerization, reversible addition—fragmentation chain transfer polymerization, or anionic polymerization including living anionic polymerisation. Preferably the acrylate polymer used in accordance with the present invention has a number average molecular weight of from 1000 to 100,000 as measured by standard ¹H nmr techniques.

The acrylate polymer is preferably a telechelic polymer having terminal curable silyl groups, for example polybutyl acrylate having terminal curable silyl groups. The curable silyl groups can for example be derived from a silyl-substituted alkyl acrylate or methacrylate monomer. Hydrolysable silyl groups such as dialkoxyalkylsilyl or trialkoxysilyl groups can for example be derived from a dialkoxyalkylsilylpropyl methacrylate or trialkoxysilylpropyl methacrylate. When the acrylate polymer has been prepared by a polymerisation process which forms reactive terminal groups, such as atom transfer radical polymerization, chain transfer polymerization, or living anionic polymerisation, it can readily be reacted with the silyl-substituted alkyl acrylate or methacrylate monomer.

The acrylate polymer can alternatively contain grafted, pendant or copolymerised curable silyl groups. For example a silyl-substituted alkyl acrylate or methacrylate monomer can be copolymerised with other acrylate monomers such as butyl acrylate, or an acrylate polymer containing pendant reactive groups can be reacted with a silyl compound having coreactive groups.

A secondary sealant containing hydrolysable silyl groups such as dialkoxyalkylsilyl or trialkoxysilyl groups is generally self-curable, but it is often preferred that the secondary sealant composition contains a trialkoxysilane as crosslinker for the hydrolysable silyl groups. Examples of suitable trialkoxysilanes include methyltrimethoxysilane, ethyltrialkoxysilane, vinyltrimethoxysilane, methyltriethoxysilane and vinyltriethoxysilane. The trialkoxysilane crosslinker can for example be present at 1 to 15% by weight of the sealant composition.

The cross-linker may also comprise a disilaalkane of the formula:

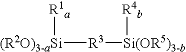

where R¹ and R⁴ are monovalent hydrocarbons, R² and R⁵ are alkyl groups or alkoxylated alkyl groups, R³ is a divalent hydrocarbon group and a and b are 0 or 1. Specific examples include 1,6-bis(trimethoxysilyl)hexane 1,1-bis(trimethoxysilyl)ethane, 1,2-bis(trimethoxysilyl)ethane, 1,2-bis(trimethoxysilyl)propane, 1,1-bis(methyldimethoxysilyl)ethane, 1,2-bis(triethoxysilyl)ethane, 1-trimethoxysilyl-2-methyldimethoxysilylethane, 1,3-bis(trimethoxyethoxysilyl)propane, and 1-dimethylmethoxysilyl-2-phenyldiethoxysilylethane.

An alkyltrialkoxysilane in which the silicon bonded alkyl group is substituted by a polar functional group can act as both crosslinker and adhesion promoter. Examples of such silanes are aminosilanes such as 3-aminopropyltrimethoxysilane, 3-(2-aminoethylamino)propyltrimethoxysilane, 3-aminopropyltriethoxysilane or 3-aminobutyltrimethoxysilane, or mercaptosilanes such as 3-mercaptopropyltrimethoxysilane.

Such an adhesion promoter can for example be present at 0.01 to 10% by weight of the sealant composition.

A secondary sealant containing hydrolysable silyl groups preferably contains a catalyst for the condensation of the hydrolysed silyl groups. Suitable catalysts include organotin catalysts or a compound of a transition metal such as titanium or zirconium. Examples of organotin catalysts are di(n-butyl)tin bis-ketonates and dibutyltin dicarboxylates such as dibutyltin dilaurate. The amount of such an organotin catalyst can for example be 0.01-3% by weight of the sealant composition.

Examples of suitable titanium compound catalysts include titanium alkoxides, otherwise known as titanate esters. Zirconium alkoxides (zirconate esters) can alternatively be used. Titanate and/or zirconate based catalysts may comprise a compound according to the general formula Ti[OR⁵]₄ and Zr[OR⁵]₄ respectively where each R⁵ may be the same or different and represents a monovalent, primary, secondary or tertiary aliphatic hydrocarbon group which may be linear or branched containing from 1 to 10 carbon atoms. Optionally the titanate may contain partially unsaturated groups. However, preferred examples of R⁵ in titanates include but are not restricted to methyl, ethyl, propyl, isopropyl, butyl, tertiary butyl, 2-ethylhexyl and a branched secondary alkyl group such as 2,4-dimethyl-3-pentyl. Preferably, when each R⁵ is the same, R⁵ is an isopropyl, branched secondary alkyl group or a tertiary alkyl group, in particular, tertiary butyl. Preferred zirconate catalysts include tetra-n-propyl zirconate, tetra-n-butyl zirconate and zirconium diethylcitrate.

Alternatively, the titanate may be chelated. The chelation may be with any suitable chelating agent such as an alkyl acetylacetonate such as methyl or ethylacetylacetonate. Any suitable chelated titanates or zirconates may be utilised. Preferably the chelate group used is a monoketoester such as acetylacetonate and alkylacetoacetonate giving chelated titanates such as, for example diisopropyl bis(acetylacetonyl)titanate, diisopropoxy bis(ethylacetoacetate)titanate, diisobutoxy bis(ethylacetoacetate)titanate and the like, or the catalyst can be octylene glycol titanate. Examples of suitable catalysts are additionally described in EP1254192 and WO2001/49774 which are incorporated herein by reference.

We have found that the use of titanate or zirconate catalysts improves the elastic recovery and movement capability of the moisture curing sealant compared to an organotin catalyst, giving improved resistance of the secondary sealant to weathering and ageing. The amount of a transition metal compound such as a titanate ester present as catalyst can for example be 0.01-5% based on the weight of the silyl acrylate polymer plus crosslinking agent.

The curable silyl groups of the acrylate polymer can alternatively be Si—H groups. The acrylate polymer can for example contain terminal dimethylhydrogensilylpropyl groups. When the curable silyl groups are Si—H, the secondary sealant composition generally contains a crosslinker having at least two ethylenically unsaturated groups, and a hydrosilylation catalyst. The crosslinker containing ethylenically unsaturated groups can be an organopolysiloxane having at least two silicon-bonded alkenyl-functional groups per molecule, in which the alkenyl group is preferably linear having up to 6 carbon atoms, as exemplified by hexenyl, vinyl, allyl or pentenyl, or may be cycloalkenyl such as cyclohexenyl. Alternatively or additionally the crosslinker can be an am-diene of the formula CH₂═CH(CH₂)_{d}CH═CH₂ where d is 1-20, such as 1,4-pentadiene; 1,5-hexadiene; 1,6-heptadiene; 1,7-octadiene; 1,8-nonadiene; 1,9-decadiene; 1,11-dodecadiene; 1,13-tetradecadiene or 1,19-eicosadiene. Suitable hydrosilylation catalysts include complexes or compounds of group VIII metals, for example, platinum, ruthenium, rhodium, palladium, osmium and indium. Preferred hydrosilylation catalysts are platinum compounds or complexes including chloroplatinic acid, platinum acetylacetonate, complexes of platinous halides with unsaturated compounds, for example, ethylene, propylene, organovinylsiloxanes and styrene, hexamethyldiplatinum, PtCl₂.PtCl₃ and Pt(CN)₃. Alternatively the catalyst may be a rhodium complex, for example, RhCl₃(Bu₂S)₃. The catalyst is typically used at 40 to 250 parts per million by weight platinum (or other group VIII metal) based on the weight of the sealant composition.

Alternatively the secondary sealant can be an acrylate polymer composition comprising an acrylate polymer having ethylenically unsaturated groups, an organosilicon material having Si—H groups, and a hydrosilylation catalyst. The ethylenically unsaturated groups can for example be allyl groups, derived for example from the polymerisation of allyl acrylate or methacrylate, or vinyl groups. The acrylate polymer is preferably a telechelic polymer having terminal ethylenically unsaturated groups, formed for example by end-capping by reaction with allyl acrylate, but can alternatively be pendant groups formed by copolymerisation of allyl acrylate with other acrylate ester monomers. The Si—H groups of the organosilicon material react with the ethylenically unsaturated groups to crosslink the acrylate polymer and thereby cure the sealant. If the acrylate polymer is a telechelic polymer having terminal ethylenically unsaturated groups, the organosilicon material preferably has at least three Si—H groups, for example it can be a polysiloxane containing methylhydrogensiloxane units, optionally with dimethylhydrogensilyl terminal groups. If the acrylate polymer contains a plurality of ethylenically unsaturated groups, for example a random copolymer of allyl acrylate and other acrylate ester monomer units formed by radical polymerisation, the organosilicon material can be a polysiloxane containing terminal Si—H groups and/or Si—H groups along the polymer chain such as methylhydrogensiloxane units. The hydrosilylation catalyst can be any of the preferred hydrosilylation catalysts described above.

The acrylate polymer containing curable silyl groups, or the composition comprising an acrylate polymer having ethylenically unsaturated groups and an organosilicon material having Si—H groups, can form up to 90% by weight of the secondary sealant composition but is preferably present at 10 to 60%. The sealant composition can for example contain a plasticiser, a rheological agent to improve the flow properties of the sealant and/or one or more fillers. Examples of plasticizers include ester plasticizers such as phthalates, for example alkyl benzyl phthalates such as butyl benzyl phthalate or dialkyl phthalates such as dioctyl phthalate. The plasticizer can for example be present at 0 to 50% by weight of the sealant composition, preferably 5 to 25%. Examples of rheological agents include thixotropic agents such as castor oils, polybutadiene containing carboxylic groups. The rheological agent can for example be present at 0 to 5% by weight of the sealant composition.

Examples of fillers include calcium carbonate, which can be precipitated calcium carbonate and/or ground calcium carbonate, zeolites, or silica, including fumed silica, fused silica and/or precipitated silica. The filler can for example be present at 0 to 70% by weight of the sealant composition, preferably 20 to 65%.

The insulating glass unit in general comprises at least two glass sheets and may contain more than two panes of glass, for example a triple pane unit comprising a central pane separated from two outer panes by spacers. The glass sheets in the insulating glass unit can be identical panes or can be different, for example one pane may be laminated glass with the other monolithic glass. One or both of the panes can be photocatalytic glass or coated glass. The glass panes are usually the same size but can be different as known in ‘stepped’ insulating glass units.

The insulating glass unit of the invention can use any of a wide variety of types of spacer. Most preferably, the insulating glass unit comprises glass sheets (panes) which are held apart and adhered to one another by a thermoplastic spacer. During assembly of such a unit, the spacer is applied as a strand, for example by extrusion, onto a first of the two glass panes along its edge. The beginning and the end of the strand are joined. The glass panes are then assembled and pressed together to a predetermined distance apart, equal to the width that the spacer is to have in the insulating glass unit, so that the strand of thermoplastic material is pressed against the glass panes and bonds the panes together. This process is described in more detail in EP-A-433386, EP-A-805254, WO-A-95/11363, WO-A-95/11364 and U.S. Pat. No. 5,961,759.

The thermoplastic material can for example be a polyolefin, for example polyisobutylene, hydrogenated polybutadiene or a poly(alpha-olefin) and/or an elastomeric thermoplastic material such as butyl rubber. It can optionally be modified with reactive groups promoting adhesion to glass, for example silanol or alkoxysilyl groups. A two-part composition can be used in which one component is a polyolefin such as polyisobutylene, hydrogenated polybutadiene or a poly(alpha-olefin) having terminal or pendant alkoxysilyl groups and the other component contains unmodified polyisobutylene, hydrogenated polybutadiene or poly(alpha-olefin) and a filler containing sufficient moisture to cure the alkoxysilyl groups when the two components are mixed just before application to the glass. Such a thermoplastic spacer usually contains a desiccant such as a zeolite molecular sieve, and may also contain other additives such as tackifier, wax and/or stabilisers such as a UV absorber.

The secondary sealant of the invention can be a layer of the curable acrylate polymer composition located at the periphery of the insulating glass unit between the edge portions of the glass panes, such that the layer of secondary sealant is in contact with external surface of the spacer, as described in EP-B-916801. The secondary sealant can be applied between the glass sheets in a fluid state and allowed to cure, for example in the presence of moisture if the acrylate polymer contains hydrolysable silyl groups.

The spacer can alternatively be a mastic, for example a polyisobutylene mastic, containing a reinforcement which helps to keep the glass sheets the required distance apart when the insulating glass unit is assembled. The mastic can contain a desiccant as described above. The reinforcement can for example be a corrugated metal reinforcement held within the mastic. The secondary sealant layer is located at the periphery of the insulating glass unit between the edge portions of the glass panes, such that the layer of sealant is in contact with external surface of the reinforced mastic.

A thermoplastic spacer based on a polyolefin, and particularly one based on polyisobutylene, has very low gas permeability. The secondary sealant of the invention maintains low permeability even if a defect develops in the thermoplastic spacer (primary sealant) which causes it to become more permeable to gases.

The spacer can alternatively be a foamed plastics material, for example a silicone foam or a polyolefin foam such as an ethylene propylene diene terpolymer foam, preferably containing a desiccant as described above. Such a foam spacer is generally fixed between the glass sheets by an adhesive such as a pressure sensitive adhesive. The secondary sealant is applied at the periphery of the insulating glass unit between the edge portions of the glass panes, outside the spacer.

The spacer can alternatively be a hollow section, for example an aluminium or stainless steel section or a hollow section of rigid plastics material, generally containing a desiccant. Such a hollow section spacer can be fixed between the glass sheets by a primary sealant, with the secondary sealant of the invention applied at the periphery of the insulating glass unit between the edge portions of the glass panes, outside the spacer. Alternatively a single sealant can be used to surround the hollow section so that it both fixes the spacer to the glass sheets and is located at the periphery of the insulating glass unit between the edge portions of the glass panes, outside the spacer. The secondary sealant of the invention can advantageously be used as such a single sealant.

The invention will now be described with reference to the accompanying drawings, of which:

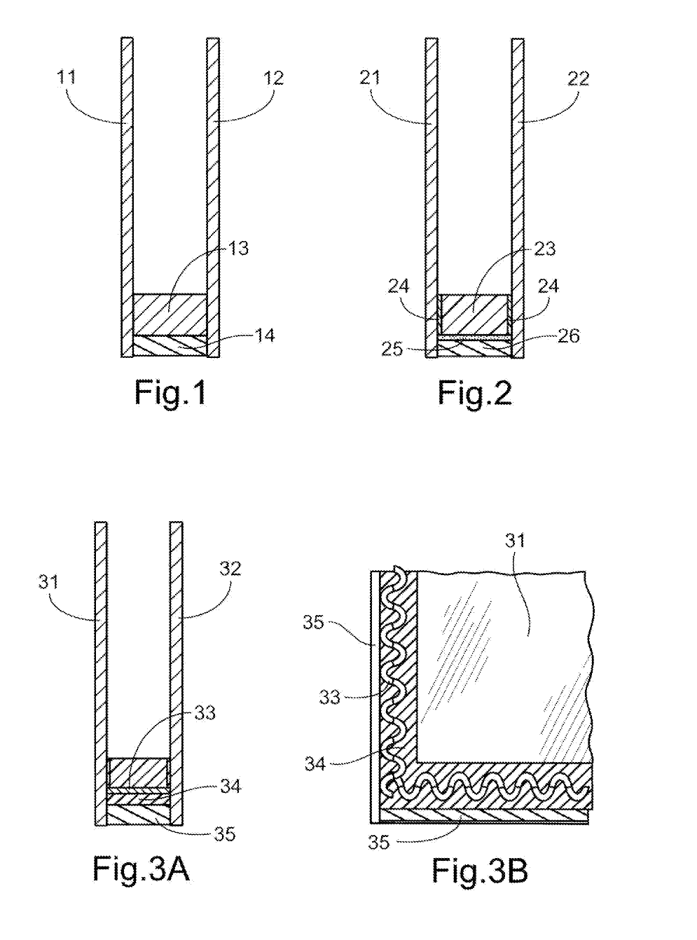

FIG. 1 is a diagrammatic cross-section of one type of insulating glass unit;

FIG. 2 is a diagrammatic cross-section of an alternative type of insulating glass unit;

FIG. 3A is a diagrammatic cross-section of another alternative type of insulating glass unit;

FIG. 3B is a diagrammatic sectioned side view of the insulating glass unit of FIG. 3A;

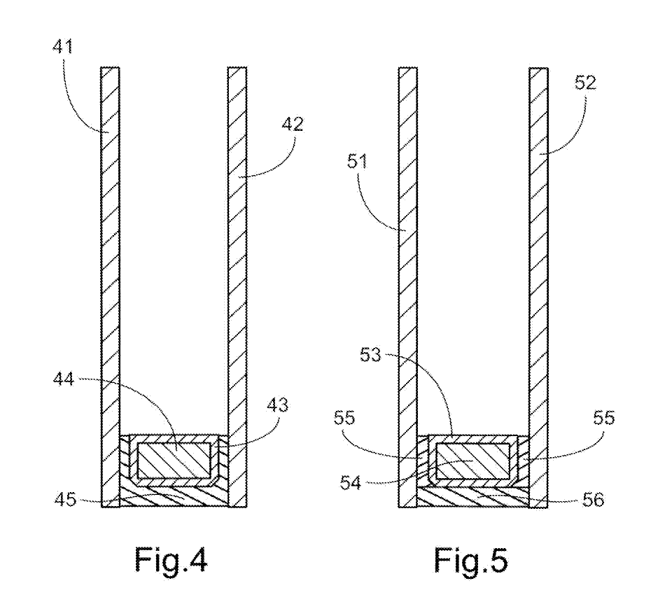

FIG. 4 is a diagrammatic cross-section of another alternative type of insulating glass unit; and

FIG. 5 is a diagrammatic cross-section of another alternative type of insulating glass unit.

The insulating glass unit of FIG. 1 comprises glass panes 11, 12 separated by a spacer 13 of the thermoplastic type which is formed in situ and comprises for example polyisobutylene filled with a desiccant. The secondary sealant 14 is formed at the edge of panes 11, 12 in contact with the outer surface of the spacer 13.

The insulating glass unit of FIG. 2 comprises glass panes 21, 22 separated by a spacer 23 formed of plastics foam, for example silicone foam or ethylene propylene diene terpolymer foam containing desiccant. The foam spacer 23 is secured in position by adhesive layers 24, for example of acrylic pressure sensitive adhesive. The outer surface of the foam spacer 23 is covered by a gas barrier film 25, for example of ‘Mylar’ (Trade Mark) polyester. The secondary sealant 26 is applied outside the film 25 at the edge of panes 21, 22.

The insulating glass unit of FIGS. 3A and 3B comprises glass panes 31 and 32. The spacer separating panes 31, 32 comprises a corrugated metal reinforcing sheet 33 surrounded by a mastic 34, for example a polyisobutylene mastic filled with a desiccant. The secondary sealant 35 is formed at the edge of panes 31, 32 in contact with the outer surface of the mastic 34.

The insulating glass unit of FIG. 4 comprises glass panes 41, 42 separated by an aluminium box spacer comprising an aluminium hollow section 43 containing a desiccant 44. The secondary sealant of the invention is applied as the single sealant 45 which bonds the aluminium box 43 to the panes 41, 42 and seals the outer edge of the panes 41, 42 outside the box 43.

The insulating glass unit of FIG. 5 also comprises glass panes 51, 52 separated by an aluminium box spacer comprising an aluminium hollow section 53 containing a desiccant 54. FIG. 5 shows a double seal unit in which a primary sealant 55 bonds the aluminium box 53 to the panes 51, 52 and the secondary sealant of the invention 56 seals the outer edge of the panes 51, 52 outside the box 53.

The invention is illustrated by the following Examples, in which parts and percentages are by weight.

### EXAMPLES 1 TO 3

Secondary sealant compositions were prepared according to the formulations given in Table 1, in which the following abbreviations are used:

Kaneka SA100S—a telechelic polybutyl acrylate containing terminal 3-(methyldimethoxysilyl)propyl groups available from Kaneka Corp.
Santicizer 261A—alkylbenzylphthalate plasticizer available from Ferro Corp.
PB—carboxylated polybutadiene
GCC—ground calcium carbonate
PCC—precipitated calcium carbonate
VTMO—vinyltrimethoxysilane
MTMS—methyltrimethoxysilane
Z-6020—3-(2-aminoethylamino)propyltrimethoxysilane
Mercapto—3-mercaptopropyltrimethoxysilane
DBTBK—di(n-butyl)bis(2,4-pentanedionato)tin catalyst
TDIDE—diisopropoxy bis(ethylacetoacetate)titanate

TABLE 1

| | Example 1 | Example 2 | Example 3 |
|---|---|---|---|
| | Parts | Parts | Parts |
| SA 100S | 33 | 33 | 33 |
| S261A | 11.5 | 11.6 | 11.6 |
| PB | 0.6 | 0.6 | 0.6 |
| GCC | 9 | 9 | 9 |
| PCC | 43 | 43 | 43 |
| VTMO | 2 | 1.4 | 1.2 |
| Z-6020 | 0.7 | 0.1 | 0.1 |
| Mercapto | | | 0.2 |
| DBTBK | 0.24 | | |
| TDIDE | | 1.1 | 1.1 |
| MTMS | | 0.2 | 0.2 |

The material of each of Examples 1 to 3 is a paste easily applicable at room temperature and is moisture curing to give a high modulus seal. Each formulation was applied as a 3.2 mm film on polyethylene and the skin over time (SOT) and the tack free time (TFT) were measured by lightly touching the film surface with a finger tip, pressing hard enough to leave an indentation if the SOT is reached, and slowly drawing the finger away. Testing is repeated every minute until the sample does not adhere to the finger tip (TFT). The results are shown in Table 2.

TABLE 2

| | Example 1 | Example 2 | Example 3 |
|---|---|---|---|
| SOT (min) | 28 | 39 | 49 |
| TFT (hours) | 7 h < x < 16 h | 2 h 45 | 3 h |
| Tackiness after cure | Tacky | Non tacky | Non tacky |

Adhesion tests were carried out on the materials of Example 1 to 3 and a comparative material C1. C1 is a commercially available silicone based formulation sold under the Trade Mark Dow Corning® 3-0117 Sealant as a secondary silicone sealant, which comprises a silicone curable polymer, calcium carbonate, a crosslinker, a titanate catalyst and an adhesion promoter. Beads of sealant were applied to two glass plates to form an H-piece and allowed to cure at 23° C. and 50% relative humidity (RH). The adhesion to glass was assessed after various days D of cure, with 3 samples of each of Examples 1 to 3 being tested for each time period. In the adhesion assessment, the H-piece was tested with a tensiometer (Zwick) and the mode of failure was rated as follows:

AF: adhesive failure—poor adhesion)
BF: boundary or mixed mode (adhesive/cohesive) failure—acceptable adhesion
CF: cohesive failure—excellent adhesion
The results are shown in Table 3

TABLE 3

| Days of | | | | |
|---|---|---|---|---|
| cure | C1 | Example 1 | Example 2 | Example 3 |
| 7 | CF | | | |
| 14 | | 1BF, 1CF, 1CF/BF | 2BF, 1BF/CF | 3CF |
| 21 | CF | 2CF/BF, 1BF | 2 BF/CF, 1BF | 2BF, 1CF |
| 28 | | 2CF, 1BF/CF | 3BF | 2BF/CF, 1AF/BF |
| 35 | | 3CF | 3BF | 3BF/CF |

Further adhesion tests were carried out in which beads of the materials of Examples 1 and 2 and of Cl were applied to two glass plates to form an H-piece and allowed to cure at 23° C. and 50% RH for 35 days (only 7 days for Cl which is known to fully cure in that time) and then subsequently exposed to various testing environments, namely

7 days in water at room temperature (r/t);
7 days in water at 60° C.;
500 hours irradiation by a UV lamp while at 95% RH;
500 hours irradiation by a UV lamp while at 50% RH;
500 hours irradiation by a UV lamp while at 95% RH and under a tensile force causing a constant 10% elongation;
24 hours at −20° C. with no recovery to room temperature (only two samples tested).

After exposure, the H-pieces were tested with a tensiometer (Zwick) and the adhesion was assessed as described in the adhesion test above. The results are shown in Table 4

TABLE 4

| Exposure test | C1 | Example 1 | Example 2 |
|---|---|---|---|
| 7 days in r/t water | 3CF | 3BF | 3BF |
| 7 days in 60° C. water | 3CF | 3BF | 3BF |
| 7 days in 60° C. dry heat | 3CF | 2CF 1 BF/CF | 2BF/CF 1 CF |
| 500 hrs UV + 95% RH | 3CF | 2BF/CF 1 CF | 3CF |
| 500 hrs UV | 3CF | 2BF 1CF/BF | 3BF |
| Constant 10% elongation + | 1CF 2AF | 3CF | 2CF 1 BF |
| UV + 95% RH 500 hrs | | | |
| cold temperature −20° C./ | 3CF | 1BF 1CF | 1BF/CF 1BF |
| 24 hrs no recovery | | | |

Further adhesion tests were carried out in which beads of the materials of Examples 1 and 2 and of Cl were applied to 2 edge deleted glasses (glass on which a low emittance coating has been stripped off) and allowed to cure at 23° C. and 50% RH for 35 days (only 7 days for Cl which is known to fully cure in that time) and then subsequently exposed to testing environments, namely

7 days in water at r/t;
7 days in water at 60° C.;
7 days in 60° C. dry heat;
500 hours irradiation by a UV lamp while at 50% RH.
After cure (2 samples), the H-pieces were tested with a tensiometer (Zwick). The same adhesion test was carried out after each exposure (3 samples). The results are shown in Table 5.

TABLE 5

| Exposure test | C1 | Example 1 | Example 2 |
|---|---|---|---|
| Cured | CF | break of glass | 1BF 1CF |
| | | (good as CF) | |
| 7 days in r/t water | CF | 1BF/CF; 1BF; 1 CF | 2CF 1BF/CF |
| 7 days in 60° C. water | CF | 2CF 1BF | 2CF 1BF |
| 7 days in 60° C. dry heat | CF | 3CF | 1BF/CF 1BF 1CF |
| 500 hrs UV | CF | 3CF | 3CF |

Further adhesion tests were carried out in which beads of the materials of Examples 1 to 3 and of Cl were applied to a stainless steel spacer bar and allowed to cure at 23° C. and 50% RH for 35 days (only 7 days for Cl which is known to fully cure in that time) and then subsequently exposed to testing environments, namely

7 days in water at r/t (2 samples);
7 days in water at 60° C. (1 sample);
After cure (2 samples), the H-pieces were tested with a tensiometer (Zwick). The same adhesion test was carried out after each exposure. The results are shown in Table 6.

TABLE 6

| Exposure test | C1 | Example 1 | Example 2 | Example 3 |
|---|---|---|---|---|
| Cure only | 2CF | 2CF | 1AF 1CF | 2CF |
| 7 days r/t water | 1CF 1AF | 2CF | 1AF 1AF/CF | 2CF |
| 7 days 60° C. water | CF | 1AF/CF | 1AF/CF 1AF | 1CF 1AF/CF |

The permeability of films of the materials of Examples 1 and of the comparative material C1 to various gases was measured on a Mocon permeation analyzer as cm³ of the gas at standard temperature and pressure (STP) passing through the film per cm² area per cm thickness of film per cmHg pressure difference across the film, and the results were shown in Table 7.

TABLE 7

| Gas | C1 | Example 1 |
|---|---|---|
| Nitrogen | 247 | 11 |
| Oxygen | 510 | 27 |
| Argon | 516 | 25 |

As can be seen from Tables 3 to 7, the materials of Examples 1 to 3 have generally satisfactory adhesion to the materials used in insulating glass units, although not quite as high as the commercial material C1. The material of Examples 1 has a permeability to various gases about twenty times lower than C1, sufficient to make a significant difference to the overall gas permeability of an insulating glass unit.

The tensile properties of the materials of Example 1 to 3 and the comparative material C1 were measured. The tensile properties were measured on dumbbells after 21 days cure (7 days for C1) and on H-pieces after 35 days cure. 2 mm thick ASTM D 412 dumbbell shapes were tested at 50 mm/min on a tensiometer (Zwick) until break. 12×12×50 cm³H-pieces have been stretched at 6 mm/min on a tensiometer (Zwick) until break. The results are shown in Table 8.

TABLE 8

| | | | | Exam- | Exam- | Exam- |
|---|---|---|---|---|---|---|
| | Property | Units | C1 | ple 1 | ple 2 | ple 3 |
| Dumbbells | Tensile | Mpa | 2.43 | 1.97 | 1.56 | 1.45 |
| | strength | | | | | |
| | Elongation | % | 304 | 139 | 172 | 255 |
| | E Modulus | Mpa | 1.80 | 1.30 | 0.80 | 0.80 |
| | Modulus at | Mpa | 0.98 | 1.62 | 1.19 | 1.00 |
| | 100% | | | | | |
| H-Pieces | Tensile | Mpa | 1.10 | 0.85 | 0.91 | 0.77 |
| | strength | | | | | |
| | Elongation | % | 103 | 84 | 100 | 116 |
| | E Modulus | Mpa | 1.93 | 1.65 | 1.12 | 1.06 |
| | Modulus | Mpa | 0.79 | 0.74 | 0.60 | 0.54 |
| | at 50% | | | | | |

The results shown in Table 8 confirm the suitability of the formulations of Examples 1 to 3 as secondary sealants from a mechanical properties viewpoint.

1. (canceled)

2. (canceled)

3. A secondary sealant for an insulating glass unit having low gas permeability, characterized in that the secondary sealant comprises an acrylate polymer containing curable silyl groups.

4. A secondary sealant according to claim 3, characterized in that the curable silyl groups are hydrolysable silyl groups.

5. A secondary sealant according to claim 4, characterized in that the hydrolysable silyl groups contain alkoxy groups bonded to silicon.

6. A secondary sealant according to claim 5, characterized in that the hydrolysable silyl groups are dialkoxyalkylsilyl groups of the formula —SiR'(OR)₂, in which R represents an alkyl group having 1 to 4 carbon atoms and R′ represents an alkyl or alkenyl group having 1 to 6 carbon atoms.

7. A secondary sealant according to claim 4, further comprising a trialkoxysilane or dialkoxalkylsilane as crosslinker for the hydrolysable silyl groups.

8. A secondary sealant according to claim 4, further comprising a titanate as catalyst for the condensation of the hydrolysable silyl groups.

9. A secondary sealant according to claim 3, characterized in that the curable silyl groups are Si—H groups and the secondary sealant composition further comprises a crosslinker having at least two ethylenically unsaturated groups, and a hydrosilylation catalyst.

10. A secondary sealant according to claim 3, characterized in that the acrylate polymer is a telechelic polymer having terminal curable silyl groups.

11. A secondary sealant according to claim 10, characterized in that the acrylate polymer is polybutyl acrylate having terminal curable silyl groups.

12. A secondary sealant for an insulating glass unit having low gas permeability, characterized in that the secondary sealant is an acrylate polymer composition comprising an acrylate polymer having ethylenically unsaturated groups, an organosilicon material having Si—H groups, and a hydrosilylation catalyst.

13. A sealed insulating glass unit comprising two glass sheets held apart by a spacer, with a secondary sealant between the edges of the glass sheets outside the spacer, characterised in that the secondary sealant comprises an acrylate polymer containing curable silyl groups, or an acrylate polymer composition comprising an acrylate polymer having ethylenically unsaturated groups, an organosilicon material having Si—H groups, and a hydrosilylation catalyst.

14. (canceled)

15. A sealed insulating glass unit according to claim 13, characterized in that the spacer is a thermoplastic material.

16. A sealed insulating glass unit according to claim 15, characterized in that the spacer is polyisobutylene.

17. (canceled)

18. A secondary sealant according to claim 5, further comprising a trialkoxysilane or dialkoxalkylsilane as crosslinker for the hydrolysable silyl groups.

19. A secondary sealant according to claim 6, further comprising a trialkoxysilane or dialkoxalkylsilane as crosslinker for the hydrolysable silyl groups.

20. A secondary sealant according to claim 7, further comprising a titanate as catalyst for the condensation of the hydrolysable silyl groups.
